(19) United States
(12) Patent Application Publication
(10) Pub. No.: US 2003/0206372 A1
(43) Pub. Date: Nov. 6, 2003

(54) Same size non-compatible next generation cartridge

(76) Inventor: Coen J. Warmenhoven, Colorado Springs, CO (US)

Correspondence Address: Oppenheimer Wolff & Donnelly LLP, 45 South Seventh Street, Suite 3300, Minneapolis, MN, 55402-1609, US

(21) Appl. No.: 10/137,842

(22) Filed: May 1, 2002

(51) Int. Cl. G11B 23/03

(52) U.S. Cl. 360/133

(57) ABSTRACT

A next generation disk cartridge, capable of being inserted into a next generation drive, includes dummy notches located to align with the shutter door opening arms of a previous generation disk drive. The dummy notches are defined by the housing of the disk cartridge, and are thus immovable. When the cartridge is inadvertently inserted into a previous generation disk drive, the dummy notches engage the shutter door opening arm of the previous generation drive, and prevent them from collapsing. The cartridge is thus blocked from further insertion into the previous generation disk drive.

### BACKGROUND OF THE INVENTION

The device of the present invention relates to a next generation data storage drive and data storage cartridge for use with data libraries or data jukeboxes.

As is easily appreciated by most members of today's society, information and data effect virtually all aspects of life. Computer systems are used to manage and use this data for all types of different reasons. Naturally, the storage and retrieval of data is a critical part of making these systems work.

With the increased demand for data storage comes an increased demand for capacity and speed. Consequently, engineers are always looking for ways to improve current devices, often changing the design or operation of these devices. Many times, a “next generation” will be designed, which may or may not be compatible with existing systems.

One approach to increasing storage capacity is to utilize a storage library, or jukebox, which includes multiple disk drives, multiple storage disks, and picker/placer mechanisms. As is well known, the picker/placer mechanisms are used to appropriately move the disks from storage locations to the drives.

Again, modern data storage libraries contain vast quantities of drives and data storage cartridges or disks. Many of such libraries are upgrading to next generation disks and disk drives. These previous generation drives are not compatible with the data disks of the next generation. Although they are very similar in appearance and size to the previous generation disks, the next generation disks are likely to get erased if they are inserted into a previous generation drive. Consequently, this should be avoided.

A simple solution to preventing the accidental insertion of a next generation disk into a previous generation drive, would be to make the next generation disks and drives a different size than the previous generation disks and drives. However, there are numerous reasons why the next generation disks must have cartridge geometries that are substantially identical to the cartridge geometries of the previous generation disks. For example, modern data storage libraries utilize robotic “juke box” mechanisms for the automatic retrieval and storage of the numerous disks. The grasping mechanisms on the robotic arms, and the storage slots from which the disks are retrieved, require uniform cartridge geometries if the disks of both generations are to be stored in the same library. Manufacturing efficiency is also improved if the cartridge geometries between generations are substantially identical. Further, this will allow for the gradual upgrade of libraries, should that be desirable for the user.

Other attempts have been made at providing a next generation disk that is insertable into a next generation drive but not insertable into a previous generation drive. One example of such an attempt is described in U.S. Pat. No. 6,115,212 to Kumagai. Kumagai discloses the use of relatively complicated misinsertion preventing members, namely a fixed post interacting with corner geometries of the various disks, in combination with trigger locks, and the like, to provide a selective disk drive. These components add manufacturing costs to the drive and reduce the reliability of the drive simply by adding parts. It would be advantageous to provide a cartridge design that utilizes otherwise necessary componentry, such as the shutter door opening arm, to distinguish the next generation cartridge from a previous generation cartridge.

There is thus a need for a next generation disk that cannot be inserted into a previous generation disk drive, yet has cartridge geometries that are substantially identical to previous generation disk cartridges.

There is also a need for a next generation drive capable of accepting the next generation disks.

### BRIEF SUMMARY OF THE INVENTION

The present invention addresses the aforementioned needs by providing a next generation disk cartridge that is constructed and arranged so that it cannot be inserted into a previous generation disk drive. The present invention also provides a next generation drive capable of accepting the next generation disks.

An example of a previous generation cartridge 1 is shown in FIG. 1 and FIG. 1a. The cartridge 1 includes a slideable, spring loaded shutter door 2 that, when opened, uncovers an access window 7 to a computer readable disk 8 inside the cartridge. The door 2 includes a notch 3 that is used by the previous generation drive tray loader 4 to open the shutter door 2.

FIG. 2 shows the previous generation drive tray loader 4. The drive tray loader 4 includes two shutter door opening arms 5. Each opening arm 5 rotates around a proximal end 6 and has a distal end 7 positioned to interfere with the notch 3 such that the shutter door 2 is opened by the rotation of the opening arm 5 as the cartridge 1 is inserted. The second shutter door opening arm 5 is provided so that the previous generation cartridge 1 may be operably inserted into the previous generation drive tray loader 4 upside down, thereby allowing the other side of the disk 8 to be read.

The cartridge of the present invention utilizes the shutter door opening arm 5 of the previous generation drive tray loader 4 to prevent insertion of the next generation disk into the drive tray loader 4. The cartridge of the present invention includes at least one dummy notch, incapable sliding along the leading edge of the cartridge, and positioned to interact with the shutter door opening arm 5 when inserted into the previous generation drive tray loader 4. Because the dummy notch is incapable of sliding along the leading edge of next generation cartridge, the opening arm 5 is not allowed to rotate. The next generation cartridge is thus prevented from further insertion into the drive tray loader 4.

The cartridge of the present invention also includes at least one door and corresponding notch useable to slide the door open. The notch is relocated so as not to interfere with the dummy notch. The next generation drive of the present invention has at least one opening arm that has a distal end located to interfere with the relocated notch.

### BRIEF DESCRIPTION OF THE DRAWINGS

FIG. 1 is a perspective view of a previous generation disk cartridge of the prior art;

FIG. 1a is a perspective view of a previous generation disk cartridge of the prior art with the shutter door in the open position;

FIG. 2 is a plan view of a previous generation disk cartridge being inserted into a previous generation drive tray loader of the prior art;

FIG. 3 is a perspective view of a next generation disk cartridge of the present invention;

FIG. 3a is a perspective view of a next generation disk cartridge of the present invention with one of the shutter doors in the open position while the opposite shutter door is in the closed position;

FIG. 4 is a plan view of a next generation disk cartridge being inserted into a next generation drive tray loader of the present invention;

FIG. 5 is a plan view of a next generation disk cartridge of the present invention being prevented from full insertion into a previous generation drive tray loader of the prior art; and,

FIG. 6 is a perspective view of the next generation disk drive of the present invention fully assembled.

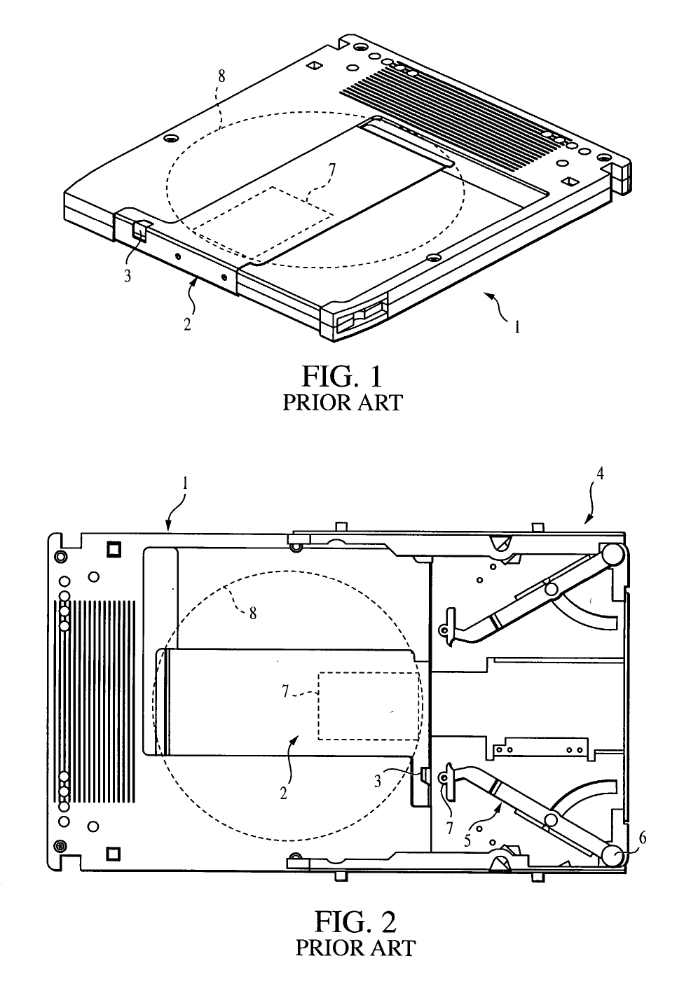

### DETAILED DESCRIPTION OF THE INVENTION

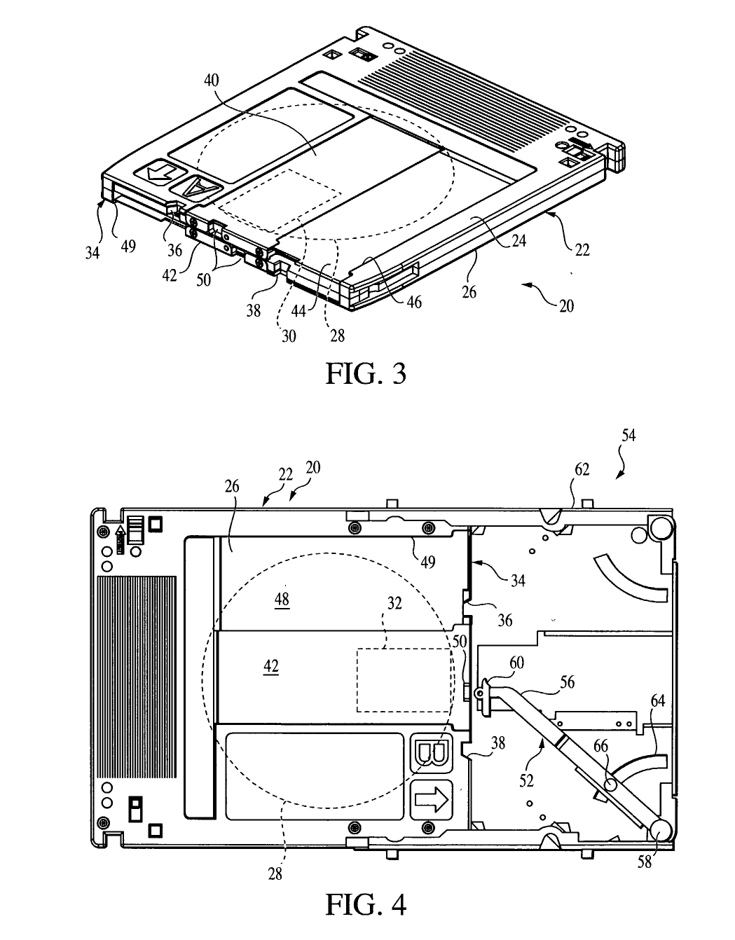

Referring now to FIG. 3 and FIG. 3a, there is shown a next generation disk cartridge 20 of the present invention. The next generation disk cartridge 20 includes a housing 22 having a first side 24 and a second side 26. An interior cavity 27 between the first side 24 and the second side 26 contains a two-sided computer readable medium, preferably in the form of a computer disk 28.

The housing 22 defines a first opening 30 in the first side 24, and preferably a second opening 32 in the second side 26. The openings 30 and 32 allow a computer read/write head to access the two sides of the disk 28 and are preferably of a standard size.

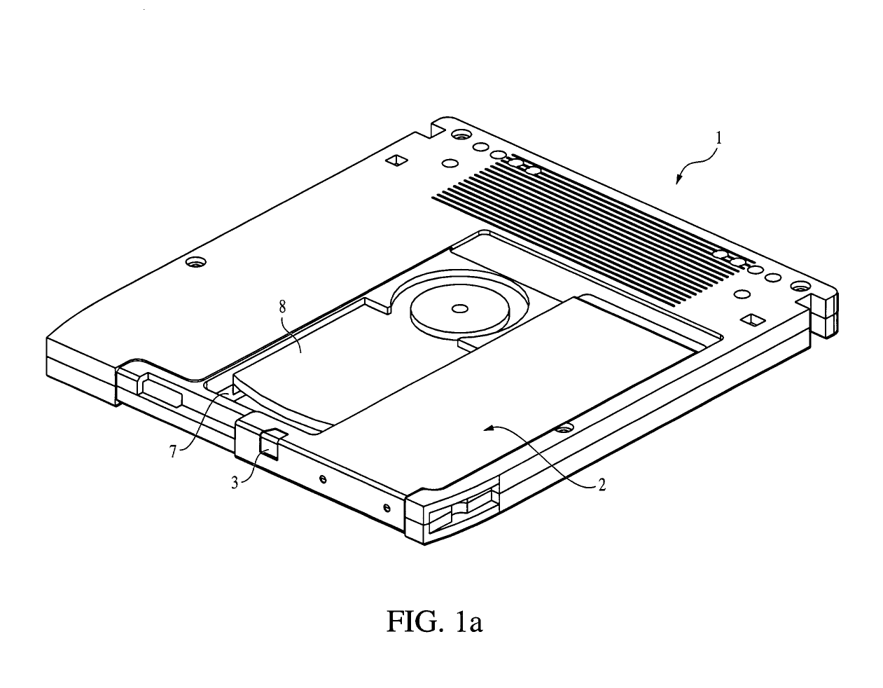

A leading edge 34 of the housing 22 includes a first dummy notch 36, and in the case of a cartridge 20 that has a two-sided disk 28, a second dummy notch 38. The dummy notches 36 and 38 are constructed and arranged to receive the distal end 7 of the shutter door opening arm 5 of the previous generation disk drive tray loader 4 (FIG. 2). Alternatively, stops (not shown) are provided which protrude slightly from the leading edge 34 and prevent the distal end 7 of the shutter door opening arm 5 of the previous generation disk drive tray loader 4 from sliding along the leading edge 34. The shutter door opening arm 5 is thus unable to collapse to allow insertion of the next generation disk cartridge 20.

As previously mentioned, the disk cartridge 20 is preferably constructed and arranged to house a two-sided disk 28. FIGS. 3 and 3a show that though the disk cartridge 20 forms a single interior cavity 28, a preferred embodiment provides two shutter doors 40 and 42. The first shutter door 40 rides within a recess 44 in the first side 24 of the housing 22. The first shutter door 40 covers the opening 30 when the first shutter door 40 is in the closed position (FIG. 3). The first shutter door 40 is biased to the closed position but may be slid to an open position (FIG. 3a) that exposes the opening 30. The recess 44 has a limiting edge 46 that abuts against the first shutter door 40 to define the extent to which it may be opened.

The second side 26 of the housing 22 is substantially identical to the first side 24. Thus, the second shutter door 42 rides within a recess 48 in the second side 26 of the housing 22. The second shutter door 42 covers the opening 32 when the second shutter door 42 is in the closed position (FIG. 3). The second shutter door 42 is biased to the closed position but may be slid to an open position (FIG. 3a shows the first shutter door 40 in the open position and the second shutter door 42 in the closed position) that exposes the opening 32. The recess 48 has a limiting edge 49 that abuts against the second shutter door 42 to define the extent to which it may be opened.

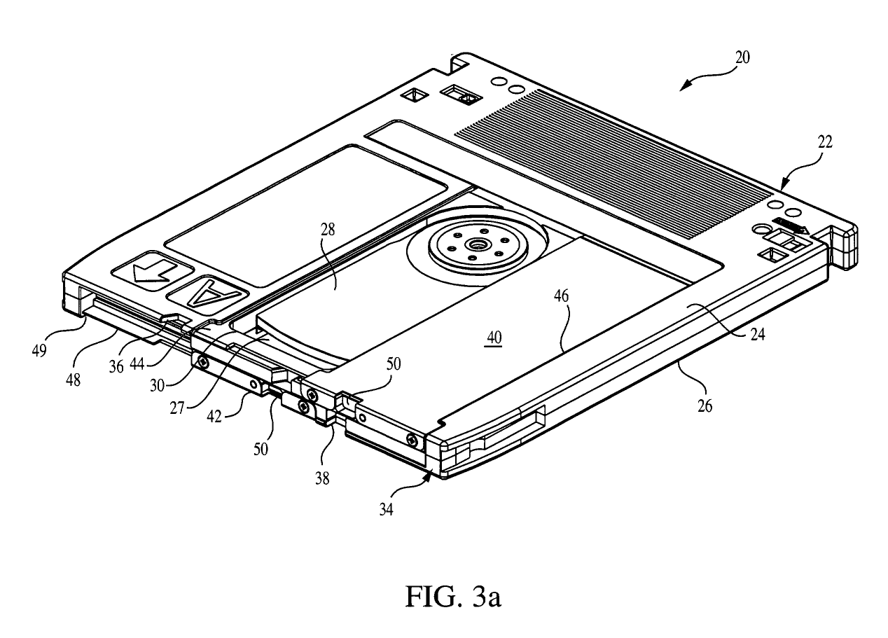

Each shutter door 40 and 42 defines a notch 50 located to operably receive a shutter door opening arm 52 of the next generation disk drive tray loader 54 (FIG. 4), which will be discussed in detail below. Notably, the two sides 24 and 26 of the body 22 are constructed and arranged such that when the next generation disk drive 22 is flipped over, the features of one side, such as the notches, shutter doors, and recesses, are located in the same places. In other words, the two sides 24 and 26 are symmetric such that the disk 20 may be inserted for operation into a drive tray loader 54 with either side 24 or 26 facing up.

Referring now to FIG. 4, there is shown the next generation drive tray loader 54 of the present invention. The next generation drive tray loader 54, in pertinent part, includes a shutter door opening arm 52 with a distal end 56 and a proximal end 58. The distal end 56 includes an engagement pad 60 configured to mate with the notch 50 of the shutter doors 40 and 42. The proximal end 58 is pivotally attached to the body 62 of the drive tray loader 54. The body 62 defines a travel slot 64 through which a guide 66, attached to the opening arm 52, rides from a first position (shown) to a second position. The opening arm 52 is biased toward the first position so the engagement pad 60 is positioned to engage the notch 50 of a disk 20 when the disk 20 is inserted.

In operation, the next generation disk cartridge 20 is inserted into the next generation disk drive tray loader 54. While being inserted, the engagement pad 60, on the distal end 56 of the shutter door opening arm 52 will mate with the notch 50. As the cartridge 20 continues to be inserted into the next generation drive tray loader 54, the opening arm 52 will pivot about the proximal end 58, and the guide 66 will travel through the travel slot 64. As the opening arm 52 rotates, the engagement pad 60 pushes open whichever shutter door 40 or 42 corresponds with the engaged notch 50.

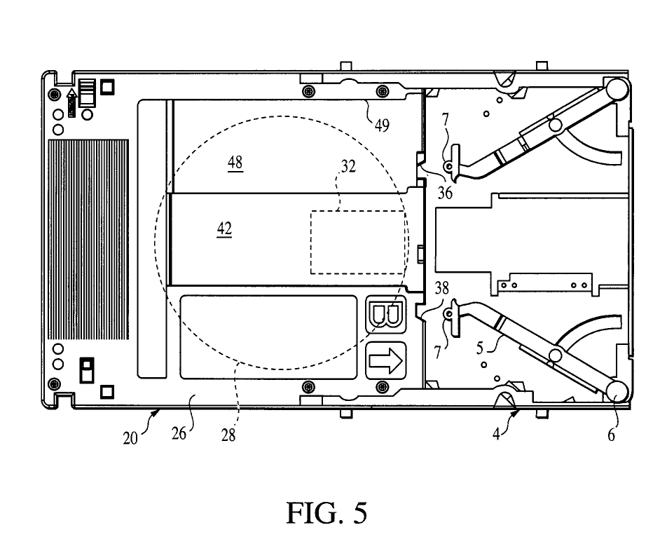

FIG. 5 shows how the next generation disk cartridge 20 is prevented from being inserted into a previous generation drive tray loader 4. As the disk 20 is inserted into the previous generation drive tray loader 4, one or both of the dummy notches 36 and 38 will line up to mate with shutter door opening arms 5 of the drive tray loader 4. However, because the dummy notches 36 and 38 are defined by the housing 22 of the cartridge 20, they will prevent the arms 5 from rotating around the proximal ends 6. The arms 5 are thus locked and the disk cartridge 20 is prevented from further insertion into the previous generation drive tray loader 4.

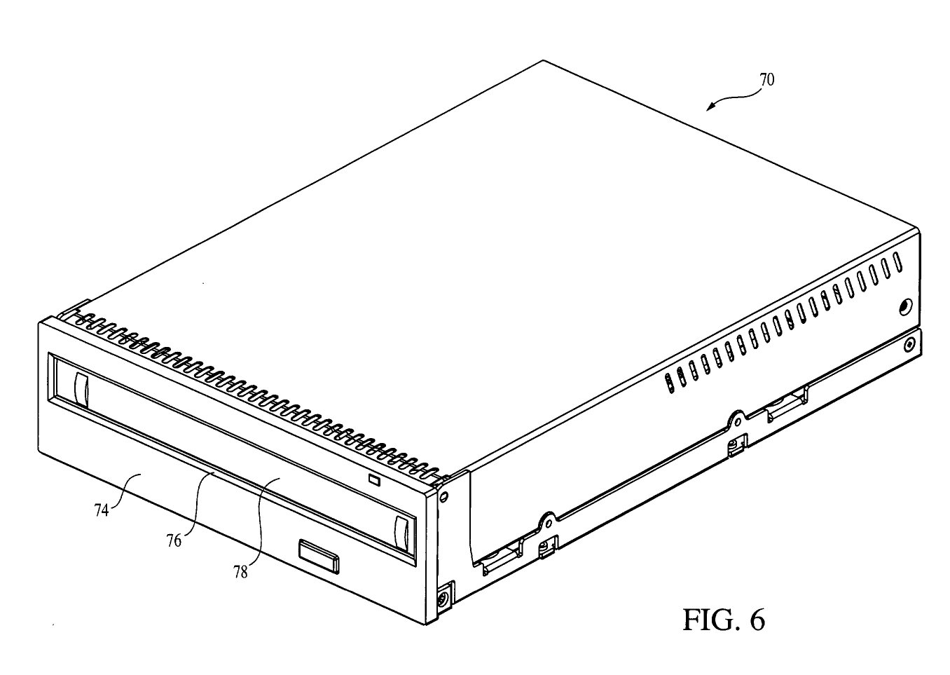

FIG. 6 shows a completely assembled next generation disk drive 70 of the present invention. The disk drive 70 includes a housing 72 that encases the disk drive tray loader 54. A front panel 74 provides an attractive face and defines a receiving port 76 through which a cartridge is loaded and unloaded. A drive door 78 covers the receiving port 76 when the drive 70 is not in use. The drive door 78 thus prevents dust and other contaminants from entering the disk drive 70.

It is contemplated that features disclosed in this application can be mixed and matched to suit particular circumstances. Various other modifications and changes will be apparent to those of ordinary skill in the art without departing from the spirit and scope of the present invention. Accordingly, reference should be made to the claims to determine the scope of the present invention.

What is claimed is:

1. A cartridge, useable to house a computer readable medium, comprising:
a housing having a first side and a second side and defining an interior cavity between the first side and the second side, the interior cavity shaped to contain a computer readable medium, the housing further defining a first opening in the first side through which a computer drive can access one side of the computer readable medium, the housing further defining a first dummy notch located to receive a shutter door opening arm of a previous generation disk drive; and,
a first shutter door operably attached to the housing and slideable between a closed position and an open position, whereby when said shutter door is in said closed position, said shutter door covers said opening, whereby when said shutter door is in said open position, said shutter door uncovers said opening, whereby said shutter door defines a notch located to operably receive a shutter door opening arm of a next generation disk drive.

2. The cartridge of claim 1 wherein said housing is constructed and arranged such that it may be inserted into a next generation disk drive in at least two orientations.

3. The cartridge of claim 2 wherein said housing further defines a second opening in the second side through which the computer drive can access another side of the computer readable medium, the housing further defining a second dummy notch located to receive the shutter door opening arm of the previous generation disk drive.

4. The cartridge of claim 3, further comprising a second shutter door operably attached to the housing and slideable between a closed position and an open position, whereby when said second shutter door is in said closed position, said second shutter door covers said second opening, whereby when said second shutter door is in said open position, said second shutter door uncovers said second opening, whereby said second shutter door defines a second notch located to operably receive the shutter door opening arm of the next generation disk drive.

5. The cartridge of claim 2 wherein said housing is symmetric.

6. A method for preventing a next generation disk from being erased due to insertion into a previous generation disk drive comprising providing an interference means on a housing encasing the next generation disk, the interference means placed to prevent a shutter door opening arm of the previous generation disk drive from moving, thereby preventing the housing from being fully inserted into the previous generation disk drive.

7. The method of claim 6 wherein providing an interference means comprises encasing the next generation disk in a cartridge housing having a dummy notch formed in a leading edge of the housing, the leading edge constructed and arranged such that the dummy notch receives a distal end of the shutter door opening arm when the housing is inserted into the previous generation disk drive.

8. The method of claim 6 further comprising providing a shutter mechanism operably attached to the housing encasing the next generation disk that will operate with a next generation drive.

9. A next generation disk cartridge comprising:
a housing means for protecting an enclosed next generation computer disk;
an access means, defined by the housing means, for providing operable access to the disk by a disk drive;
a means, operably attached to the housing means, for covering said access means when said access means is not being used by the disk drive;
a prevention means, operably attached to the housing means, for preventing the housing means from being inserted into a previous generation disk drive.

10. The next generation disk cartridge of claim 9, wherein said housing means comprises a housing, having a first side and a second side and defining an interior cavity between the first side and the second side, the interior cavity shaped to contain a computer readable medium.

11. The next generation disk cartridge of claim 9 wherein said access means comprises an opening defined by the housing.

12. The next generation disk cartridge of claim 9 wherein said means for covering said access means comprises a shutter door operably attached to the housing means and slideable between a closed position and an open position, whereby when said shutter door is in said closed position, said shutter door covers said access means, whereby when said shutter door is in said open position, said shutter door uncovers said access means.

13. The next generation disk cartridge of claim 12 wherein said means for covering said access means further comprises a notch, defined by said shutter door, located to operably receive a shutter door opening arm of a next generation disk drive.

14. The next generation disk cartridge of claim 9 wherein said prevention means comprises a dummy notch, defined by said housing means, located to receive a shutter door opening arm of the previous generation disk drive.
